(19) United States
(12) Patent Application Publication
(10) Pub. No.: US 2001/0054447 A1
(43) Pub. Date: Dec. 27, 2001

(54) Structure faucet water diversion device

(76) Inventor: Chu-Cheng Kuo, Sangchung City (TW)

Correspondence Address: Chu-Cheng, Kuo, P.O. Box 1-252, Sanchung City, TW

(21) Appl. No.: 09/840,535

(22) Filed: Apr. 23, 2001

(30) Foreign Application Priority Data
May 18, 2000 (TW) 089208334

(51) Int. Cl. F16K 11/087

(52) U.S. Cl. 137/625.46

(57) ABSTRACT

An improved structure faucet water diversion device comprised of a body having disposed in the center a stepped bore and in its lateral surface and contiguous with the stepped bore is a threaded hole and a horizontal columnar passage penetrating the stepped through-hole such that a revolvable liquid rechannelling shaft can be pivotably installed into the horizontal columnar passage and a water output coupling screwed into the threaded hole. Respectively installed to the upper and lower extent of the body is a ring nut and a water filtering spout. The revolvable liquid rechannelling shaft consists of a round chambered column having a revolvable button-type handle situated at one end and disposed in the column in a crisscrossed arrangement and also perpendicular to its axial center is a through-hole and a stepped hole, and nested in the stepped hole is a steel ball and a spring. As such, after the column is then pivotably installed into the horizontal columnar passage of the body, the rotation of the revolvable liquid rechannelling shaft controls whether water flows from the water filtering spout or from the water output coupling.

### BACKGROUND OF THE INVENTION

1) Field of the Invention

The invention herein relates to an improved structure faucet water diversion device, specifically one that is simple in structure, easy to assemble, convenient to operate and utilize and, furthermore, in which water seeping and leakage as well as malfunctioning does not readily occur.

2) Description of the Prior Art

Conventional faucet water diversion devices (as shown in FIG. 6 and FIG. 7) are typically “piston-type” faucet water diversion devices that are convenient to operate and utilize (it is only necessary to move the handle and does not require pulling to enable water flow to a water filter or a water purifier); however, based on manufacturer and consumer response after utilization, the following shortcomings still remain:

1. The design of the said conventional faucet water diversion devices is actually based on the commonly utilized “ball valve” and as a result, in addition to the ball valve body 30 requiring on it an axial through-hole 31 and a detent groove 30, a water diverting angle guide slot 32 is also necessary and, therefore, manufacturing and finishing work is very problematic and disadvantageous and, furthermore, finishing standards are difficult to maintain, often leading to defective products.

2. When the ball valve body 30 is installed into the ball valve chamber 11 of the main body 10, a sealing ring 34 must be placed at both its upper and lower extents and, furthermore, an upper stop 20 must be screwed onto the top section of the said main body 10; however, the said upper stop 20 has to be screwed on at a sufficient degree of tightness; if it is overtightened, the said ball valve body 39 is incapable of being actuated by the drive stem 40 when moved by the handle 50, thereby precluding the rotation needed for water diverting action; if it is too loose, water leakage occurs; moreover, when new products are released from the factory, the upper stop 20 is already adjusted to a certain tightness, but following a brief period of utilization, both the upper and lower sealing rings 34 become worn, which also results in water leakage.

3. The handle 50 requires a bolt 54 to secure it onto the drive stem 40 and since loosening and dislodging readily occurs, this frequently results in user inconvenience and frustration; additionally, the inadvertent loss of the bolt 54 precludes operation, rendering the device useless.

4. In such conventional faucet water diversion devices, the “water diversion” control structure design is comprised of a ball valve body 30, two sealing rings 34, a drive stem 40, a handle 50, and a main body 10 to which the said structural components are assembled; with such numerous structural components, fabrication and assembly consumes much time and effort; and since the said drive stem 40 must be pivotably installed into a columnar passage 142 of the handle base 14 and into the valve chamber 11 of the said main body 10, the assembly task poses considerable difficulty and inconvenience.

5. The said upper stop 20 has at its top end a thread fastening component 23 for a secure installation which not only involves more inconvenience in the task of screw fastening to the upper end of the main body 10, but also presents further difficulty during loosening and tightening and, therefore, effecting adjustments during assembly and utilization is quite troublesome.

In view of the said standing imperfections and utilization difficulties due to the structural design of conventional faucet water diversion devices, the inventor of the invention herein conducted research and testing to successfully innovate the improved structure faucet water diversion device of the invention herein

### SUMMARY OF THE INVENTION

The objective of the invention herein is to provide an improved structure faucet water diversion device that is simple in structure, easy to assemble, convenient to operate as well as utilize and, furthermore, in which water seeping and leakage as well as malfunctioning does not readily occur.

### BRIEF DESCRIPTION OF THE DRAWINGS

FIG. 1 is an isometric drawing of the invention herein.

FIG. 2 is a cross-sectional drawing of the invention herein as viewed from the perspective of line 2-2′ in FIG. 1 when the revolvable handle, indicated by the invisible line, is turned to provide flowing water from the water output coupling.

FIG. 3 is a cross-sectional drawing of the invention herein as viewed from the perspective of line 3-3′ in FIG. 1 when water is flowing through the water filtering spout.

FIG. 4 is a cross-sectional drawing of the invention herein as viewed from the perspective of line 3-3′ in FIG. 1, but when water is flowing from the water output coupling.

FIG. 5 is an exploded drawing of the invention herein.

FIG. 6 is a cross-sectional drawing of a conventional faucet water diversion device with its handle 50 in a vertical state.

FIG. 7 is a cross-sectional drawing of a conventional faucet water diversion device with its handle 50 in a horizontal state.

### DETAILED DESCRIPTION OF THE INVENTION

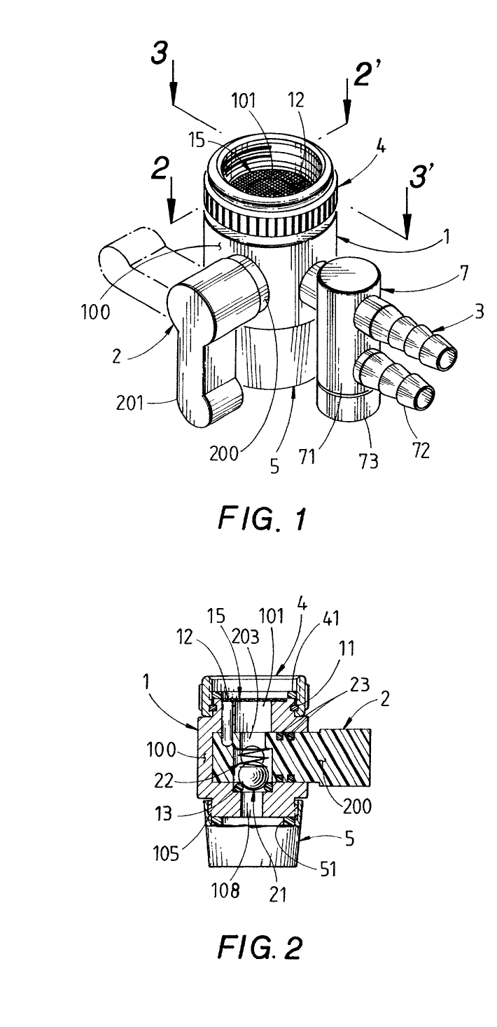

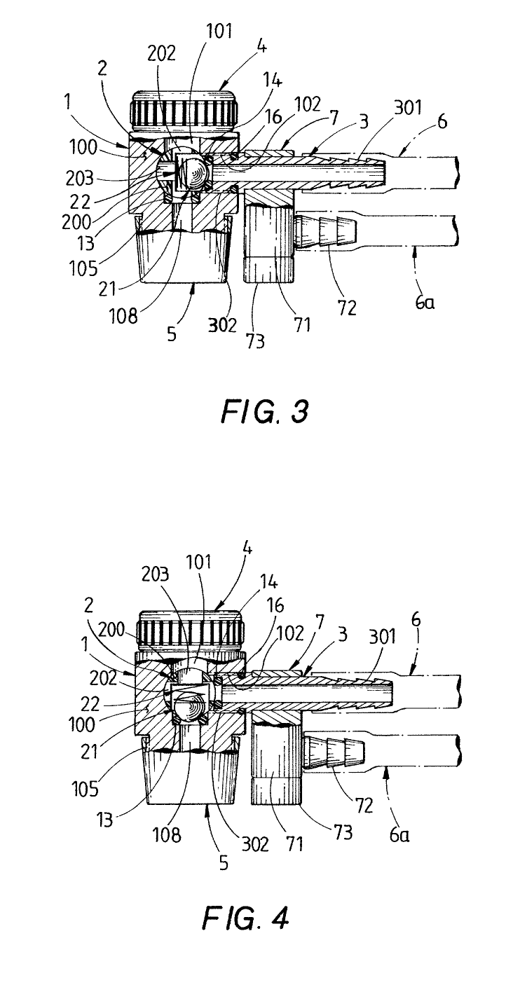

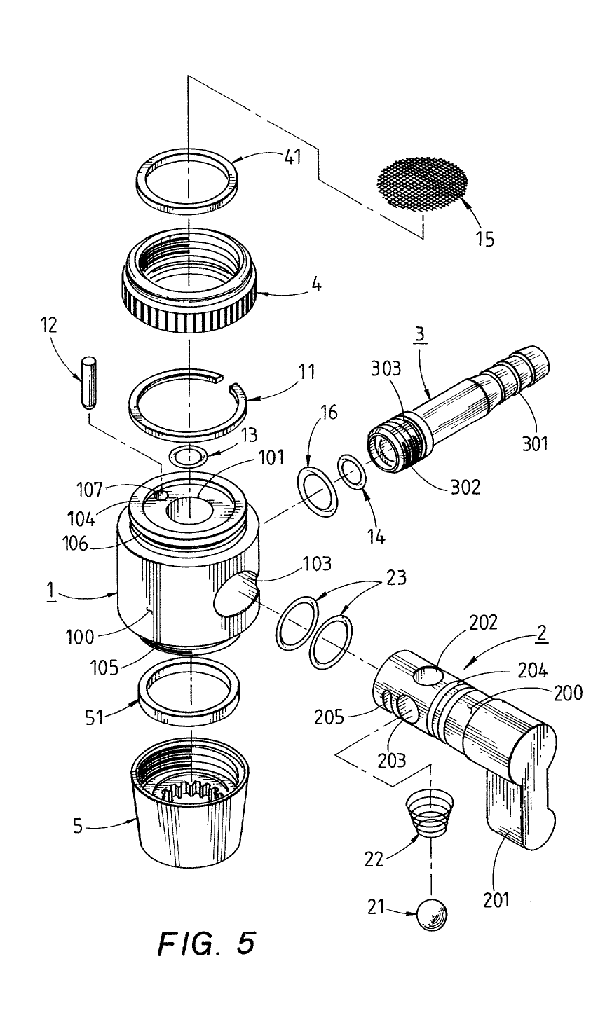

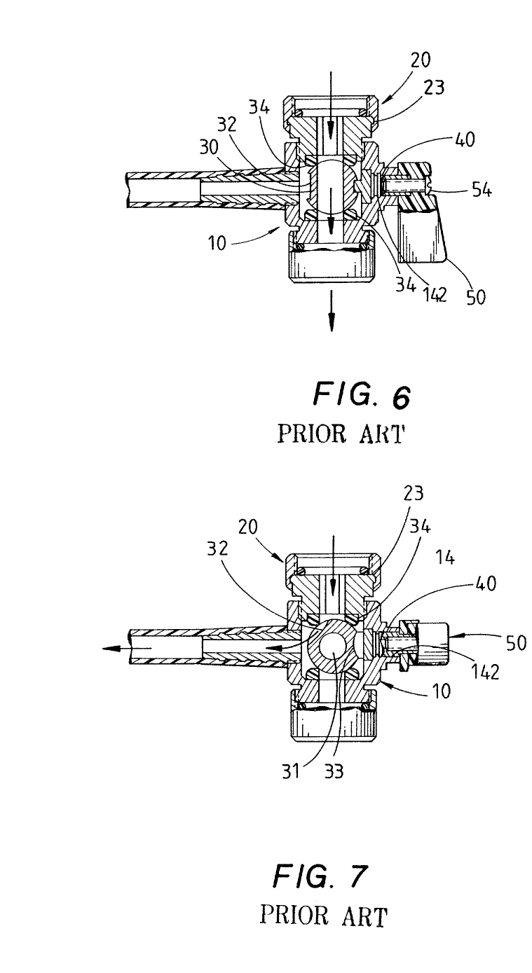

Referring to FIG. 1, FIG. 2, FIG. 3, and FIG. 5, the improved structure faucet water diversion device of the invention herein is comprised of a body 1 that has pivotably installed in it a revolvable liquid rechannelling shaft 2 and a thread fastened water output coupling 3 and, furthermore, respectively installed to the upper and lower extent of the said body 1 is a ring nut 4 and a water filtering spout 5; and installed on the said revolvable liquid rechannelling shaft 2 is a steel ball 21 and a spring 22.

The body 1 consists of a cylindrical block 100 having disposed in the center a stepped bore 101 and in its lateral surface and contiguous with the said stepped bore 101 is a threaded hole 102 (as shown in FIG. 3 and FIG. 4) as well as a horizontal columnar passage 103 (as shown in FIG. 2 and FIG. 5) that penetrates the said stepped through-hole 101, respectively enabling the threaded fastening of the said water output coupling 3 and the pivotal installation of the said revolvable liquid rechannelling shaft 2; at the upper end of the said cylindrical block 100 is an annular groove 106 of a short projecting pipe 104 such that a C-shaped tensile ring 11 enables the securely threaded installation of the ring nut 4 of the faucet; at the lower side of the said block 100 is a male threaded connector 105 that enables the direct screw fastening of the water filtering spout 5; in the upper aspect of the said short projecting pipe 104 is a small hole 107 contiguously extending to the horizontal columnar passage 103 that enables the insertion of a pin 12 which fixes the position of the revolvable liquid rechannelling shaft 2 pivotably installed in the horizontal columnar passage 103.

The revolvable liquid rechannelling shaft 2, as indicated in FIG. 2 and FIG. 5, consists of a round chambered column 200 having a revolvable button-type handle 201 situated at one side; the said column 200 has disposed in a crisscrossed arrangement and also perpendicular to its axial center a through-hole 202 and a stepped hole 203, and nested in the said stepped hole 203 is the steel ball 21 and the spring 22 (as shown in FIG. 2, FIG. 3, and FIG. 4); formed proximal to the anterior end of the said column 200 are a minimum of two annular grooves 204 into which are seated two rubber washers 23 such that when it is pivotably installed into the horizontal columnar passage 103 in the body 1 block 100 water seeping and leakage do not occur; and formed proximal the posterior end is an arc-shaped indentation 205 that accommodates the insertion of the said pin 12 and fixes the position of the said pin 12.

The water output coupling 3 of the invention herein in addition to having a fitting 301 at one end that is inserted into pliant tubing 6 (as shown in FIG. 3 and FIG. 4) also has at its other end screw fastening attachment threads 302, with an annular groove 304 formed around the neck section for the ensleeving of a leakproof rubber washer 16; furthermore, at the end face of the said attachment threads 302 is a stratiform retaining edge 303 (as shown in FIG. 5) enabling the insertion of a rubber washer 14 that is instrumental to the obstructing action of the steel ball 21 on the revolvable liquid rechannelling shaft 2; for the same reason, a rubber washer 13 must be placed inside the stepped bore 101 centered in the block 100 of the body 1 to similarly facilitate the obstructing action of the steel ball 21 on the revolvable liquid rechannelling shaft 2.

When the improved structure faucet water diversion device of the invention herein is assembled, referring once again to FIG. 1 and FIG. 2, the rubber washer 13 is first placed inside the stepped bore 101 centered in the body 1 block 100; the rubber washers 23 are then seated into the two annular grooves 204 formed on the column 200 of the revolvable liquid rechannelling shaft 2 and, furthermore, after the steel ball 21 and the spring 22 are installed into the stepped hole 203, the column 200 is directly inserted into the horizontal columnar passage 103 of the said block 100, following which the pin 12 is inserted into the small hole 107 in the short projecting pipe 104 at the top end of the said block 100 to fix the said revolvable liquid rechannelling shaft 2 in position; at the same time, a filter screen 15 is firmly installed to the top surface of the short projecting pipe 104 at the upper end of the said block 100; finally, with the rubber washer 16 ensleeved around its neck section and, furthermore, the rubber washer 14 inserted at its end face, the water output coupling 3 is directly screwed into the threaded hole 102 in one side of the said block 100; following the installation of the C-shaped tensile ring 11 into the annular groove 106 at the said upper end of short projecting pipe 104, the ring nut 4 with a rubber washer 41 ensconced inside is installed onto it; and the water filtering spout 5 fitted with a rubber washer 51 is directed screwed onto the male threaded connector 105 at the lower side to complete the assembly of the improved structure faucet water diversion device of the present invention, the assembly thereof being quite simple and rapid.

As indicated in FIG. 1 and FIG. 3, when the revolvable button-type handle 201 of the revolvable liquid rechannelling shaft 2 in the improved structure faucet water diversion device of the invention herein is in an up-down vertical state, the stepped hole 203 in the round chambered column 200 of the revolvable liquid rechannelling shaft 2 is in a horizontally oriented (level) state (as shown in FIG. 3), wherein the nested steel ball 21 obstructs the threaded hole 102 in one side of the body 1 block 100 such that water does not flow through the water output coupling 3 towards a water filter or a water purifier (not shown in the drawings), but flows straight out of the water filtering spout 5 at the lower side of the body 1 to provide the user water for washing usage; when the user turns the revolvable button-type handle 201 of the revolvable liquid rechannelling shaft 2 to a left-right horizontal state, as indicated by the invisible line section of FIG. 1, the stepped hole 203 in the round chambered column 200 of the revolvable liquid rechannelling shaft 2 is brought into a vertically oriented state (the state shown in FIG. 2 and FIG. 4), causing the steel ball 21 to obstruct the upper edge of a water output opening 108 at the lower end of the stepped bore 101 centered in the block 100 of the body 1 such that water does not flow through the water filtering spout 5, but is redirected to flow from the water output coupling 3 and conveyed via the pliant tubing 6 to a water filter or a water purifier for filtering or purifying treatment to provide the user water for drinking and other uses.

Since water faucets specifically designed for water filters and purifiers are usually not installed in most residential architectural structures, wash (cleaning) basins are typically equipped with general purpose faucets in which a greater or lesser amount of sediment produced during water filter or water purifier operation is present in the water dispensed. The improved structure faucet water diversion device of the invention herein is purpose-built for use on wash (cleaning) basins to support water filter and purifier applications and as such, the water output coupling 3 of the present invention is of an additionally lengthened arrangement and installed in a mounting diverticulum 7 having at its lower end a water output opening 71 and a water input coupling 72; and screwed onto the water output opening 71 is a small water filtering spout 73 (as indicated in FIG. 1, FIG. 2, and FIG. 3), with the said water input coupling 72 inserted into a pliant tubing 6a to guide water from the water output coupling 3 to a water filter or a water purifier (not shown in the drawings) such that when the said revolvable button-type handle 201 of the improved structure faucet water diversion device of the present invention is turned to the left-right horizontal state, water from the faucet flows through the pliant tubing 6 towards a water filter or a water purifier to undergo filtering or purifying treatment; and following the filtering or purifying treatment, the water courses back into the said mounting diverticulum 7 via the other pliant tubing 6a and flows out of the small water filtering spout 73 at the lower end of the said mounting diverticulum 7 to provide the user water for drinking and other uses; if sediment is present in the water dispensed, it can be discharged into the wash (cleaning) basin and directly drained out without the positioning of a drip pan or container.

Due to its superior structural design, the improved structure faucet water diversion device of the invention herein has the following special features and efficacy:

1. Since the steel ball 21 of the present invention is constructed of a hardened durable material, when nested in the stepped hole 203 in the column 200 of the revolvable liquid rechannelling shaft 2, a bolstering spring 22 is installed against its back surface; at the same time, since the rubber washers 14 and 13 are respectively installed at the end face of the said attachment threads 302 of the water output coupling 3 and inside the stepped bore 101 centered in the block 100 of the body 1, when the water output coupling 3 or the water output opening 108 at the lower end of the block 100 are operationally obstructed, this effectively ensures that no water seeping and leakage occurs; furthermore, although the said steel ball 21 is not readily susceptible to wear, when it has been in long-term utilization and becomes slightly worn, the reinforcing effect against it by the spring 22 ensures the integrity of the said operational obstruction and precludes any malfunctioning.

2. In the present invention, since two rubber washers 23 are seated on the column 200 of the revolvable liquid rechannelling shaft 2, when it is pivotably installed into the horizontal columnar passage 103 of the body 1 block 100, water seepage and leakage does not occur.

3. Except for the installation of the ring nut 4 which requires mechanical assistance or a tool to accomplish its secure threaded conjoinment onto the upper end of the body 1 block 100, since all the other structural components of the invention herein can be manually inserted, pivoted in, or screwed on to thereby facilitate quick completion, the assembly work involved is quite easy and rapid.

4. After the invention herein is completely assembled, since it can be installed without any further adjustment of tightness and, furthermore, requires no adjustment during utilization, installation and utilization is convenient.

1. An improved structure faucet water diversion device comprised of a body that has pivotably installed in it a revolvable liquid rechannelling shaft and a thread fastened water output coupling and, furthermore, respectively installed to the upper and lower extent of the said body is a ring nut and a water filtering spout; and installed on the said revolvable liquid rechannelling shaft is a steel ball and a spring, wherein:
The said body consists of a cylindrical block having disposed in the center a stepped bore and in its lateral surface and contiguous with the said stepped bore is a threaded hole and a horizontal columnar passage penetrating the said stepped through-hole; at the upper end of the said cylindrical block is an annular groove of a short projecting pipe such that a C-shaped tensile ring enables the threaded installation of the said ring nut of the faucet; at the lower side of the said block is a male threaded connector that enables the direct screw fastening of the said water filtering spout; in the upper aspect of the said short projecting pipe is a small hole contiguously extending to the said horizontal columnar passage that enables the insertion of a pin that fixes the position of the said revolvable liquid rechannelling shaft pivotably installed in the said horizontal columnar passage:
The said revolvable liquid rechannelling shaft consists of a round chambered column having a revolvable button-type handle situated at one side; the said column has disposed in a crisscrossed arrangement and also perpendicular to its axial center a through-hole and a stepped hole, and nested in the said stepped hole is the said steel ball and the said spring; formed proximal to the anterior end of the said column are a minimum of two annular grooves into which are seated two rubber washers such that when the said column is pivotably installed into the said horizontal columnar passage in the said body block, water seeping and leakage do not occur; and formed proximal the posterior end is an arc-shaped indentation that accommodates the insertion of the said pin and fixes the position of the said pin.
The said water output coupling has at the end face of its screw fastening attachment threads a stratiform retaining edge for the insertion of a rubber washer that is instrumental to the obstructing action of the said steel ball on the said revolvable liquid rechannelling shaft.
Placed inside the said stepped bore centered in the said block is a rubber washer that similarly facilitates the obstructing action of the said steel ball on the said revolvable liquid rechannelling shaft.

2. As mentioned in claim 1 of the improved structure faucet water diversion device of the invention herein, the said water output coupling is of an additionally lengthened arrangement and installed in a mounting diverticulum having at its lower end a water output opening and a water input coupling; and screwed onto the said water output opening is a small water filtering spout, with the said water input coupling inserted into a pliant tubing to guide water from the water output coupling to a water filter or a water purifier and following the filtering or purifying treatment, the water flows out of the said small water filtering spout at the lower end of the said mounting diverticulum.
